(19) United States
(12) Patent Application Publication
(10) Pub. No.: US 2025/0270034 A1
(43) Pub. Date: Aug. 28, 2025

(54) SYSTEM AND METHOD FOR SEALING WASTE PRODUCTS

(71) Applicant: MANGAS IP B.V., Hilversum (NL)

(72) Inventor: Mangas Jody Maria HOOGLAND, Hilversum (NL)

(21) Appl. No.: 18/857,851

(22) PCT Filed: Apr. 19, 2023
(86) PCT No.: PCT/NL2023/050208

§ 371 Date: Oct. 18, 2024

(30) Foreign Application Priority Data
Apr. 20, 2022 (NL) 2031637

(51) Int. Cl. B65F 1/06

(52) U.S. Cl. CPC B65F 1/062; B65F 2210/167; B65F 2210/168

(57) ABSTRACT

A system (100) and method for disposing waste products (W) in sealed packages made from a flexible tubing (T). A channel (10) is arranged for passing a waste product (W) inside a flexible tubing (T) being drawn from a supply compartment (15) over a circumferential edge (10e) formed around an entrance to the channel (10). A detection sensor (20) is configured to detect the waste product (W) being passed into the channel (10). A pulling device (30) is configured to pull a portion of the flexible tubing (T) into the channel (10) from the surrounding supply compartment (15) based on the detecting. A scaling device (40) is configured to seal a portion of the flexible tubing (T) that has been pulled into the channel (10) to form a scaled package with the waste product (W) inside.

### TECHNICAL FIELD AND BACKGROUND

The present disclosure relates to a system and method for disposing waste products in sealed packages made of a flexible tubing.

As background, EP 0 699,584 A2 describes an apparatus for packaging objects in packages made of flexible tubular material. A series of packages containing different sized objects are formed by pushing the objects in series into a funnel shaped portion of flexible tubing drawn from a pack over the rim of a funnel. Each object pushes a preceding package from between spring-loaded jaws to take its place. Each package is closed at the top by twisting the tubing by turning the funnel fixed to the pack about its axis.

As further background, U.S. Pat. No. 6,516,588 B2 describes a sealable diaper-disposal system and method for packaging odorous waste objects in individual sealed (substantially air-tight) packages. The system includes a body, base, hinged lid, flexible material, and a first sealing member and second sealing member. The sealing members are operable to seal or form a substantially air-tight seal in the flexible material to prevent the odor from escaping. The sealing members move between an open position and closed/sealing position by twisting an inner lid, closing the lid, or moving an activation arm. The sealing members preferably seal the tubing by thermally fusing the tubing.

There is a need for further improving reliability and convenience in an apparatus and method for sealing waste products such as diapers, bandages and feminine hygiene products.

### SUMMARY

Aspects of the present disclosure relate to systems and methods for disposing waste products in sealed packages made from a flexible tubing. Waste products can be passed in a channel of the disposal system. In use, the channel is lined with a flexible tubing which can be drawn from a surrounding supply compartment. By providing a sensor, the system may detect the waste product being passed into the channel. By automatically pulling a portion of the flexible tubing from the surrounding supply compartment into the channel, the waste product can be carried with the tubing to a designated position where it can be sealed inside the tubing to form a package.

### BRIEF DESCRIPTION OF DRAWINGS

These and other features, aspects, and advantages of the apparatus, systems and methods of the present disclosure will become better understood from the following description, appended claims, and accompanying drawing wherein:

FIG. 1 illustrates a system for disposing waste products;

FIG. 2 illustrates a cut-away view inside part of the system;

FIGS. 3A-3C illustrates a mechanism for pulling a flexible tubing into a channel for disposal of a waste product;

FIGS. 4A-4C illustrate further aspects of the mechanism for pulling the flexible tubing into the channel;

FIGS. 5A and 5B illustrate aspects of a sealing device;

FIGS. 6A-6C illustrate aspects of another sealing device;

FIGS. 7A and 7B illustrate aspects of another sealing device;

FIG. 8 illustrates modular parts of the system.

### DESCRIPTION OF EMBODIMENTS

Terminology used for describing particular embodiments is not intended to be limiting of the invention. As used herein, the singular forms “a”, “an” and “the” are intended to include the plural forms as well, unless the context clearly indicates otherwise. The term “and/or” includes any and all combinations of one or more of the associated listed items. It will be understood that the terms “comprises” and/or “comprising” specify the presence of stated features but do not preclude the presence or addition of one or more other features. It will be further understood that when a particular step of a method is referred to as subsequent to another step, it can directly follow said other step or one or more intermediate steps may be carried out before carrying out the particular step, unless specified otherwise. Likewise it will be understood that when a connection between structures or components is described, this connection may be established directly or through intermediate structures or components unless specified otherwise.

The invention is described more fully hereinafter with reference to the accompanying drawings, in which embodiments of the invention are shown. In the drawings, the absolute and relative sizes of systems, components, layers, and regions may be exaggerated for clarity. Embodiments may be described with reference to schematic and/or cross-section illustrations of possibly idealized embodiments and intermediate structures of the invention. In the description and drawings, like numbers refer to like elements throughout. Relative terms as well as derivatives thereof should be construed to refer to the orientation as then described or as shown in the drawing under discussion. These relative terms are for convenience of description and do not require that the system be constructed or operated in a particular orientation unless stated otherwise.

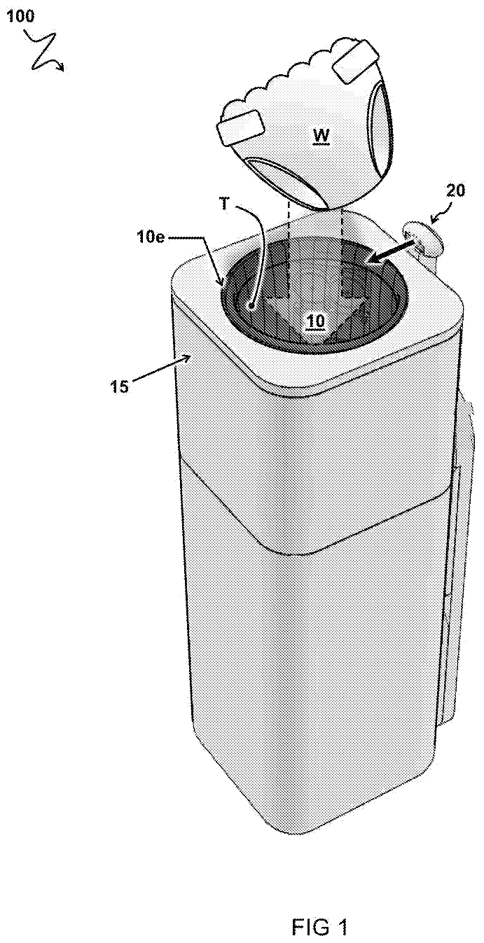

FIG. 1 illustrates a system 100 for disposing waste products W. In some embodiments, the system is configured to dispose the waste products W in sealed packages made from a preformed flexible tubing T. Preferably, the flexible tubing is preformed provided in a supply package. In other or further embodiments, the system comprises a channel 10 for passing a waste product W inside a flexible tubing T. In one embodiment, the flexible tubing T is drawn from a supply compartment 15 over a circumferential edge 10e formed around an entrance to the channel 10. In another or further embodiment, the system comprises or couples to a detection sensor 20 configured to detect the waste product W being passed via the entrance into the channel 10.

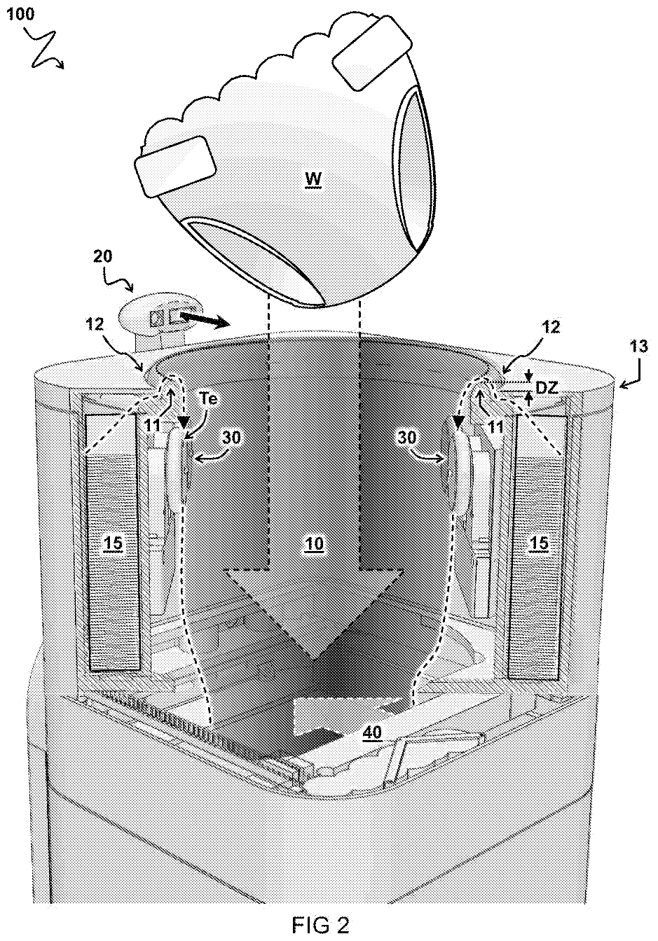

FIG. 2 illustrates a cut-away view inside part of the system 100. In some embodiments, the circumferential edge 10e is formed by a circumferential rim 11 surrounding the entrance to the channel 10. In one embodiment, the supply compartment 15 is arranged circumferentially (e.g. concentrically) around and adjacent the channel 10, e.g. at the same or overlapping height. In another or further embodiment, the supply compartment 15 comprises a circumferential slot 12 around the circumferential rim 11. For example, the circumferential slot 12 is configure to feeding the flexible tubing T from the surrounding supply compartment 15 up through the circumferential slot 12 and down over the circumferential rim 11 into the channel 10.

In some embodiments, the supply compartment 15 comprises a removable cover 13 for exchanging and/or refilling the supply of flexible tubing T. For example, the circumferential slot 51 is formed between the removable cover 13 and the circumferential rim 11. In one embodiment, the circumferential rim 11 has a rounded top profile. For example, the rounded top profile has a minimum radius of curvature of at least half a centimeter, preferably at least one centimeter, or even more than two centimeters. In another or further embodiment, the top profile of the circumferential rim 11 is provided with a relatively smooth finish. For example, the rounded top profile has a roughness grade (ISO 1302) smoother than N11 (Ra≤25 μm), preferably smoother than N10 (Ra≤12.5 μm), more preferably smoother than N9 (Ra≤6.3 μm), most preferably smoother than N8 (Ra≤3.2 μm) or even N7 (Ra≤1.6 μm). By providing the circumferential rim 11 with a rounded and/or smoothed top profile, the flexible tubing T may more easily slide over the top of the rim with minimal friction and/or reduced chance of cutting the tubing on the rim. In another or further embodiment, the top profile of the circumferential rim 11 is provided with a non-sticking material or coating, such as polytetrafluoroethylene (PTFE. better known as Teflon®).

In some embodiments, the top profile of circumferential rim 11 extends a distance DZ above the surrounding removable cover 13. For example, the distance DZ is more than half a centimeter, preferably more than one centimeter, or more than two centimeter, e.g. up to five centimeter, up to ten centimeter, up to twenty centimeter, or more. By having the rim extend a distance above the surroundings system, e.g. at least one centimeter, inadvertent fouling of the surroundings by the waste product W may be alleviated, in particular because the rim is covered by what will be the inside of the flexible tubing T (and sealed package). Additionally, by keeping the rim at a modest height, e.g. below five centimeter, the path length of the tubing is not unnecessarily extended and also friction may be kept relatively low. Also, the overall dimensions of the system can remain relatively compact. Also, the rim should not block the detection sensor 20 being able to detect the waste product W, e.g. if this is placed adjacent entrance as shown.

In some embodiments (not shown), the rim may be funnel shaped. The may provide a wider entrance and/or prevent fouling underneath. Preferably, the funnel top width is limited to an inner diameter of a container or supply package “P” for the flexible tubing T, e.g. similar to or the same as the inner diameter of the supply compartment 15 within a factor 1.2. This may allow a service person to easily resupply the system with a supply package of the flexible tubing T. In other or further embodiments, the circumferential funnel shaped rim 11 may be removable when exchanging the supply package, or the supply package may be provided from a bottom side of the supply compartment 15 and the flexible tubing T may be sufficiently flexible to be pulled over the funnel shaped circumferential rim 11.

In some embodiments, the system 100 comprise a supply mechanism configured to supply a portion, e.g. predetermined or variable length, of the flexible tubing T into the channel 10. Preferably, the system 100 comprises a pulling device 30 configured to pull a portion of the flexible tubing T into the channel 10 from the surrounding supply compartment 15. By pulling the flexible tubing T from the supply compartment 15 over the circumferential rim 11 into the channel, the tubing can be pulled tight and it can be ensured that the waste product W is pulled with the flexible tubing T into the channel for disposal. Also other or further mechanisms can be envisaged for supplying a portion of tubing. For example, the tubing can be fed from the supply compartment 15 which may also involve pushing. However, this may lead to folding or crumbling of the tubing. This may be alleviated by additionally pulling the tubing from a position inside the channel 10 as shown. Preferably, the tubing is moved into the channel 10 by mechanical means. Alternatively, or additionally, also non-mechanical means can be envisaged such as drawing a vacuum below the tubing to pull the tubing or bag (sealed tubing) into the channel. When vacuum means are used, preferably a filter is provided in a path of the evacuated air, to prevent possibly contaminated or foul air to be evacuated from the system. In case, vacuum means are used, the initial tubing should be sealed at the end, or air would simply be blown through. So, mechanical means are still preferred.

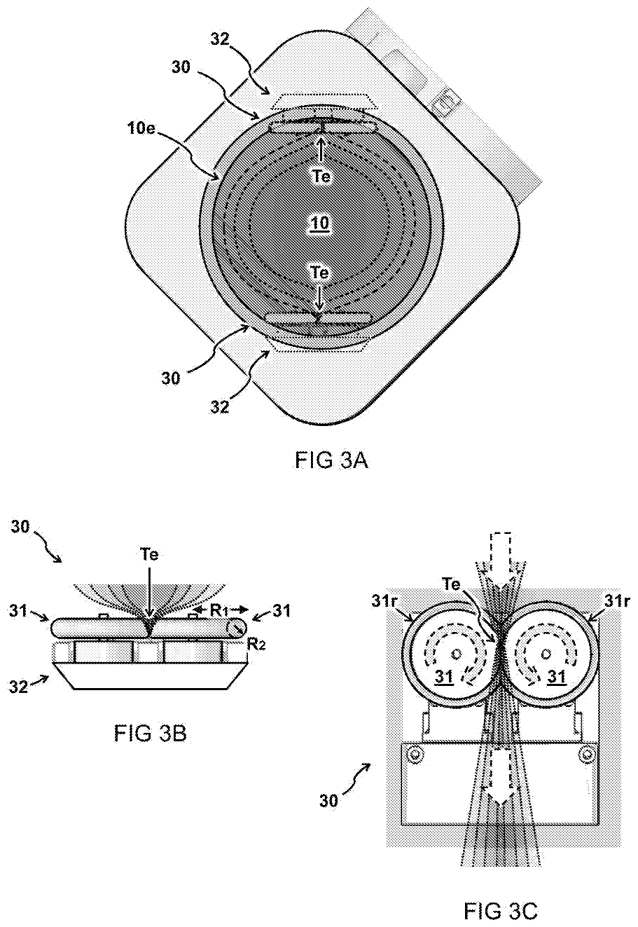

In some embodiments, the circumferential rim 11 is arranged in a path of the flexible tubing T between the supply compartment 15 and the supply mechanism, e.g. pulling device 30. In this way, the mechanical means can function as a pulling device 30 configured to pull the flexible tubing T from the supply compartment 15 over the circumferential rim 11. In one embodiment, the mechanical means, e.g. pulling device 30, comprise at least one wheel configured to contact a side of the tubing such that rotation of the wheel causes the tubing to be moved pulled and/or pushed into the channel. In some embodiments, one or more wheels to push and/or pull the tubing can be arranged along the path before the circumferential rim 11 (not shown), at the circumferential rim 11 (not shown), and/or beyond the circumferential rim 11 (as shown). Further details of a preferred pulling mechanism comprising wheels will be discussed later with reference to FIGS. 3A-3C. Advantageously, a wheel can provide a continuous actuation in one direction, e.g. as opposed to other reciprocating mechanical means which are also possible, in principle. For example, the system may alternatively, or additionally comprise a reciprocating mechanism that grabs part of the flexible tubing T and pulls this down over a distance.

In some embodiments, the system 100 comprise a disposal mechanism to dispose a portion of the flexible tubing T with the waste product W inside. While various disposal mechanisms can be envisaged, preferably the system comprises a sealing device 40 configured to automatically seal a portion of the flexible tubing T. For example, one or more seals can be formed to seal a waste product W inside. Preferably, the sealing device 40 is activated after a portion of flexible tubing T is supplied. In one embodiment, the sealing device 40 is configured to seal a part of the flexible tubing T by heat. Preferably, the sealing device 40 comprises a heating device, such as a heated wire, to seal the flexible tubing T. To provide sufficient heat for sealing, the heating device is preferably capable of reaching a temperature of at least 100° C., more preferably at least 120° C., most preferably above 150° C. (e.g. to melt typical polyethylene garbage bags). For example, the heated wire is pressed against an opposing part or vice versa. In one embodiment, the opposing part comprises a rubber strip, e.g. silicone or other (flexible) material having sufficiently high damage temperature, at least higher than the in use temperature of the heated wire. For example, while most plastics may begin to melt at high temperatures, silicone does not have a melting point and remains solid until combustion occurs. At temperatures between about 200° C. and 450° C., silicone rubber may slowly lose its mechanical properties over time, becoming brittle. So, a temperature of the heated wire is preferably controlled to be in a range below 300° C., more preferably below 200° C.

In some embodiments, the sealing device 40 is configured to clamp part of the flexible tubing T. For example, the sealing device 40 is configured to clamp two halves of the flexible tubing T together and form a sealing connection by pressure of the clamping device and/or by heat of a heating device. Also other or further methods of sealing can be envisaged, such as twisting the flexible tubing T, optionally followed by applying pressure and/or heating to form a permanent seal. Alternatively, or in addition to heating, also other forms of electromagnetic radiation may be applied, e.g. to initiate a photochemical reaction in the flexible tubing T which may cause sealing.

In some embodiments, the sealing device 40 is configured to cut off a sealed package from the flexible tubing T. In one embodiment, the sealed package is cut off by burning or melting through the flexible tubing T, e.g. by the same heating device used for sealing. For example, the heated wire can be used to seal and cut a package from the flexible tubing T. Also other or further cutting means can be provided. In another or further embodiment, the sealing device 40 comprises a knife to cut a sealed package from the flexible tubing T. For example, the sealing device 40 is configured to form a relatively wide seal or two seals, wherein the knife cuts the flexible tubing T between two sealed parts. In this way, the seal for the next package can be simultaneously provided. Alternatively, the seal for the next package can be provided after cutting off the current package. By cutting off sealed packages, clogging of the system may be alleviated. Alternatively, the system may be configured to form a string of sealed packages.

In some embodiments, the sealing device 40 is arranged in a path of the flexible tubing T beyond the pulling device 30. In other words the pulling device 30 is preferably arranged between the entrance of the channel 10, e.g. circumferential rim 11, and the sealing device 40. For example, the waste product W can be pulled with the flexible tubing Tinto the channel and pushed further by the same mechanism and/or by a weight of the waste product W be pulled further beyond the sealing device 40 to form a sealed package seal above the waste product W. In another or further embodiment (not shown), the system another or further pulling device below the sealing device 40, e.g. to pull the sealed package and/or string of packages further into a waste container below.

In some embodiments (not shown), the disposal mechanism comprises a compressor configured to compress a package with the waste product W inside prior to sealing. For example, the sealing device 40 is configured to compress not only a part the flexible tubing T for sealing, but also a part of the flexible tubing T containing the waste product W. In other or further embodiments (not shown), the disposal mechanism comprises actuation means, e.g. a compressor, beyond the sealing device 40 configured to pull, push, and/or compress packages before and/or after sealing, e.g. compress the packages in a waste container below the sealing device 40. In this way, the capacity of the system may be improved.

In some embodiments, the supply and/or disposal mechanism comprises a respective actuator that is automatically activated and/or deactivated based on a respective control signal. By activating the supply and/or disposal mechanism automatically, the user does not need to touch the system which can improve hygiene. In other or further embodiments, a control signal may be (alternatively or additionally) sent to automatically dispose a waste product W based on user input such as by interaction with a user interface. For example, a user may press a button and/or activate a foot pedal to initiate the disposal of a waste product W.

In some embodiments, the control signal is based on a sensor measurement. In another or further embodiment, the system comprises a controller configured to receive a sensor measurement and/or provide a control signal to the supply and/or disposal mechanism. In one embodiment, the controller is configured to provide a first control signal to the supply mechanism, e.g. pulling device 30, upon detecting an object such as the waste product W entering and/or passing a respective part of the channel 10 and/or the entrance to the channel, e.g. detected by the detection sensor 20. In another or further embodiment, the controller is configured to provide a second control signal to the disposal mechanism, e.g. sealing device 4, based on the detection and/or based on activation of supply mechanism. Typically, the second control signal is sent after the first control signal to ensure the waste product W is passed with the supplied portion of flexible tubing T at the right position for the disposal mechanism, e.g. below the sealing device 40.

In a preferred embodiment, the system comprises a pulling device 30 configured to automatically pull a portion of the flexible tubing T into the channel 10 from the surrounding supply compartment 15 based on the detecting of the waste product W being passed into the channel 10. In another or further preferred embodiment, the system comprises a sealing device 40 configured to automatically seal a portion of the flexible tubing T that has been pulled into the channel 10 to form a sealed package with the waste product W inside.

In some embodiments, the system comprises a controller configured to initiate disposal of the waste product W upon receiving a detection signal from the detection sensor 20 by first activating the supply mechanism, e.g. pulling device 30 to supply, e.g. pull, a portion of the flexible tubing T into the channel 10 and then activating the disposal mechanism, e.g. sealing device 40. In other or further embodiments, the automatic supply and/or disposal mechanism may be disabled and/or enabled by user input. For example, the automatic disposal mechanism may be disabled when a user or service crew is exchanging a supply package for the waste product W. In one embodiment, the system comprises a sensor for detecting whether the removable cover 13 has been removed and/or the supply compartment 15 is exposed. For example, the pulling device 30 may only activate automatically when the supply compartment 15 is closed. This may allow the service crew easily to place a new supply of flexible tubing T and provide the start of the tubing in the pulling device 30 without this device being activated. The disabling/enabling may also effected by any other user input to the system.

In some embodiments, the system, e.g. controller, is configured to control the supply mechanism, e.g. pulling device 30, to supply a predetermined length of the flexible tubing T into the channel 10. In one embodiment, the predetermined length is a fixed length, e.g. in dependence of the expected size of the waste product W intended to disposed by the system such as a such as diapers, bandages and feminine hygiene products. For example, the predetermined length is between five and eighty centimeter, preferably between ten centimeter and sixty centimeter, more preferably between fifteen and forty centimeter, most preferably between twenty and thirty centimeter. Also other ranges are possible for disposing smaller or larger products. In other or further embodiments, the system, e.g. controller, is configured to control the supply mechanism, e.g. pulling device 30, to supply a variable length of the flexible tubing T into the channel 10. In one embodiment, the variable length of supplied tubing is selected based on a sensor measurement, e.g. within a predetermined range. For example, the detection sensor 20 is configured to not only measure the presence but also the type and/or size of the waste product W, and adjust the provided length of flexible tubing T accordingly.

In some embodiments, the supply mechanism, e.g. pulling device 30 comprises a stepper motor or other mechanism to keep track of the number of rotations. In this way the supplied length of flexible tubing T can be measured, e.g. also when the mechanism is stuck or moving slowly. In other or further embodiments, a sensor is provided to measure a length of the provided flexible tubing T. For example, a sensor wheel can be integrated along the path to contact the passing tubing and measure the length supplied.

In some embodiments, the detection sensor 20 comprises an imaging sensor, e.g. camera. In another or further embodiment, the system comprises a controller programmed with an image recognition algorithm. For example, the image recognition algorithm is configured to distinguish different sizes and/or types of waste products based on an image received from the detection sensor 20. Also other or further sensors, such as a force sensor, can be provided to distinguish different waste products, e.g. by their weight. In one embodiment, the controller is configured to recognize and/or distinguish waste products based on a machine learning algorithm, e.g. trained with image or other data comprising the disposal of different types, sizes and/or weights of waste products.

Alternatively, or in addition to measurements from the detection sensor 20, also other or further sensors can be used for adapting a provided length of the flexible tubing T. In one embodiment (not shown), the system comprises an additional sensor in the channel 10 configured to detect the supplied flexible tubing T with the position and/or extent of the waste product W inside. For example, the additional sensor can detect a bulge in the flexible tubing T corresponding to the waste product W inside. In another or further embodiment, the sealing device 40 is provided with a sensor. For example, the sealing device 40 is configured to initiate a sealing operation, e.g. by attempting to clamp part of the flexible tubing T, and detect whether the clamping and/or sealing has succeeded or not. When the sealing device 40 detects it is unable to clamp part of the flexible tubing T this may correspond to the waste product W being in the way, and trigger a controller to control the supply mechanism to supply an additional length of the flexible tubing T. This may continue until a suitable sealing situation is provided, e.g. the waste product W is below the sealing device 40. In other or further embodiments, the system 100 comprises a force sensor, e.g. configured to measure a weight and/or size of the waste product W, and adapt the waste disposal process accordingly.

In some embodiments, the system 100 comprises a safety mechanism to limit a supply of the flexible tubing T. In one embodiment, the supplied length of flexible tubing T is limited per detected waste product W. For example, this may prevent the device from wasting the flexible tubing T when there is a malfunction, e.g. waste product stuck in the channel 10 and/or in front of the detection sensor 20. In another or further embodiment, the supplied flexible tubing T is limited in time. For example, system is configured to only trigger the waste disposal process a fixed number of times (e.g. once or twice) within a predetermined period of time (e.g. one minute). This may prevent abuse of the system by a user wasting the flexible tubing T by unnecessarily triggering the sensor. Alternatively, such abuse may also be prevented by specific recognition of the waste product W.

In some embodiments, the detection sensor 20 is configured to detect the presence of an object, such as a waste product W, at the entrance to the channel 10. Preferably, the detection sensor 20 is configured to exclusively detect the presence of objects directly above the entrance to the channel 10 and/or (at least partly) inside the channel 10. In this way the mechanism is not inadvertently activated. Alternatively, or in addition, a control mechanism is configured to only activate the disposal process when the detection sensor 20 measures a threshold signal and/or measures a signal maintained for a threshold period of time, e.g. corresponding to the time it takes a typical waste product passing a viewing window of the sensor.

In some embodiments, the detection sensor 20 comprises an optical sensor, e.g. based on infrared light. For example, the detection sensor 20 comprises an infrared light detector and optional light source. In one embodiment, the detection sensor 20 comprises a proximity sensor configured to detect objects in a vicinity of the entrance to the channel 10. In another or further embodiment, the detection sensor 20 comprises a sensor configured to exclusively detect objects within a threshold distance and/or range from the sensor, e.g. inside the radius of the channel entrance. In one embodiment, e.g. as shown the detection sensor 20 is mounted on top of the system 100 and/or configured to view an entrance to the channel 10. Preferably, the detection sensor 20 is mounted exclusively on one side of the channel 10, e.g. at a backside of the system which may be mounted to a wall. For example, the detection sensor 20 is based on reflection. In this way, the sensor has less chance of being fouled by the waste product W. In another or further embodiments (not shown), the detection sensor 20 comprises a source and sensor mounted at opposite sides of the entrance to the channel, e.g. forming a light gate.

Alternatively, or in addition to optical sensors, also other types of sensors can be envisaged for detecting the presence and/or absence of a waste product W above and/or inside the channel 10. In one embodiment (not shown), the system 100 comprises a force sensor configured to measure a weight of a product weighing down on the flexible tubing T. For example, a force sensor may be integrated in the circumferential rim 11 to detect a waste product W present in the channel 10, e.g. pressing by its weight on the previous seal and/or stuck in the channel. Alternatively, or additionally, a force sensor may be integrated in the pulling device 30. Also combinations of sensors can be envisaged. For example, an optical sensor at the entrance to the channel can be used to initiate a disposal process, which can be maintained until the force sensor no longer feels the weight of the waste product W (e.g. when it is sealed and cut off). Alternatively, or additionally, an optical or force sensor may be arranged to detect the waste product W passing the pulling device 30, e.g. below the sealing device 40.

FIGS. 3A-3C illustrates a mechanism for pulling a flexible tubing T into a channel 10 for disposal of a waste product W. In some embodiments, the pulling device 30 is configured to grab onto the flexible tubing T. In one embodiment, the pulling device 30 is configured to grab, e.g. pinch, a folded edge Te of the flexible tubing T, and pull the flexible tubing T, by the folded edge Te, into the channel 10. In other or further embodiments, the mechanism comprises a pulling device 30 disposed at an inside wall of the channel 10, and configured to pull the flexible tubing T into the channel 10.

In some embodiments, e.g. as shown, each pulling device 30 comprises at least two counterrotating wheels 31 (or other rollers), configured to grab, e.g. pinch, an edge Te of the flexible tubing T between the counterrotating wheels 31 and pull the flexible tubing T by the grabbed edge into the channel 10. In one embodiment, the counterrotating wheels 31 are configured to grab and actuate an outside of the flexible tubing T. For example, the at least two counterrotating wheels 31 are provided with a folded outside edge T of the flexible tubing T as illustrated. Advantageously, the counterrotating wheels 31 can rotate to pull a part of the flexible tubing T from the supply compartment and keep rolling to transport this part also beyond the pulling device 30, e.g. helped by the weight of the waste product W and/or further rollers (not shown).

In some embodiments, each pulling device 30 comprises a pair of counterrotating wheels 31 having a rounded, e.g. toroidal, outer edge. This may also be referred to as a donut shape (at least on the outer edge). For example, as shown in FIG. 3B, the wheel 31 has a first radius R1 (around an axis of the wheel, i.e. from a center of the wheel to the outer edge of the wheel); and the rounding of the outer edge of the wheel has a second radius R2 (around an circumferential axis at an outer edge of the wheel). Preferably, the second radius R2 is selected in a range between 0.05 and 0.5 times the first radius R1, more preferably between 0.1 and 0.4 times the first radius R1, e.g. around 20%, or more. Alternatively, or additionally, the second radius R2 is preferably at least half a centimeter, more preferably at least one centimeter, or more than two centimeter. Without being bound by theory, the inventor finds that providing wheels with a relatively large rounded outer edge may facilitate the flexible tubing T being more stably retained between the wheels 31 and/or cause a possible loose edge Te to be pulled into the mechanism. Alternatively, or in addition, the outer circumference of the wheels 31 may be beveled.

In some embodiments, the wheels 31 are provided with a resilient material 31r to engage the flexible tubing T. For example, the resilient material 31 is provided on the outer edge which is preferably rounded. Preferably, the resilient material 31r is relatively flexible and/or reversibly deformable. This may allow the flexible tubing T to be easily inserted between the rollers. Preferably, the resilient material 31 has an Young's modulus smaller than 1 GPa, more preferably less than 0.1 GPa, e.g. down to 0.01 GPa, or less. For example, the resilient material 31r comprises rubber which may also help to grip the flexible tubing T without slipping. Also other resilient and/or non-slipping materials can be envisaged.

In some embodiments, the pulling device 30 comprises a pair of counterrotating rollers, e.g. wheels 31, placed at a distance such that the resilient material 31r of the respective rollers touches each other, or even such that the resilient material 31r is partially compressed by the wheels pressing into each other to provide maximum grip. In other or further embodiments, the counterrotating wheels 31 are able to be pulled apart, e.g. for placing the flexible tubing T between the wheels. For example, the wheels are actuated by one or more springs to push them together and can be moved apart (slightly) to more easily push the flexible tubing T there between, e.g. by a service person replacing a pack of tubing.

In some embodiments, the system comprises at least two pulling devices 30. For example, each pulling device 30 comprises at least two wheels 31 or other counterrotating rollers. Preferably, the at least two pulling devices are distributed equidistantly around the perimeter of the channel 10, e.g. on opposite sides of the channel 10 as shown here. For example, the flexible tubing T can be pulled at the same time from different sides to more evenly supply the tubing into the channel. Furthermore, the reliability of the system may be improved because. For example, the flexible tubing T may be pulled down even if only by a single pulling device. Furthermore, a second pulling device may grab onto the flexible tubing T while it is pulled and fed into the wheels by a first pulling device.

In some embodiments, the system 100, or at least its top part, has a rectangular top profile (outer perimeter), preferably a rounded rectangle, as shown. In one embodiment, each pulling device 30 is arrange in a respective corner of the (rounded) rectangular top profile. Advantageously, the corner may allow more space for the respective actuator 32, e.g. motor, and/or other structure forming part of the pulling device 30. Preferably, the circumferential edge 10e is round, e.g. circular as shown, or oval. This may provide a maximum aperture for disposing waste products. In other or further embodiments, the outer perimeter of the system may also be round, e.g. circular or oval. For example, the pulling device 30 can be arranged in opposing sides of the oval shape, preferably the sides where the oval is longest.

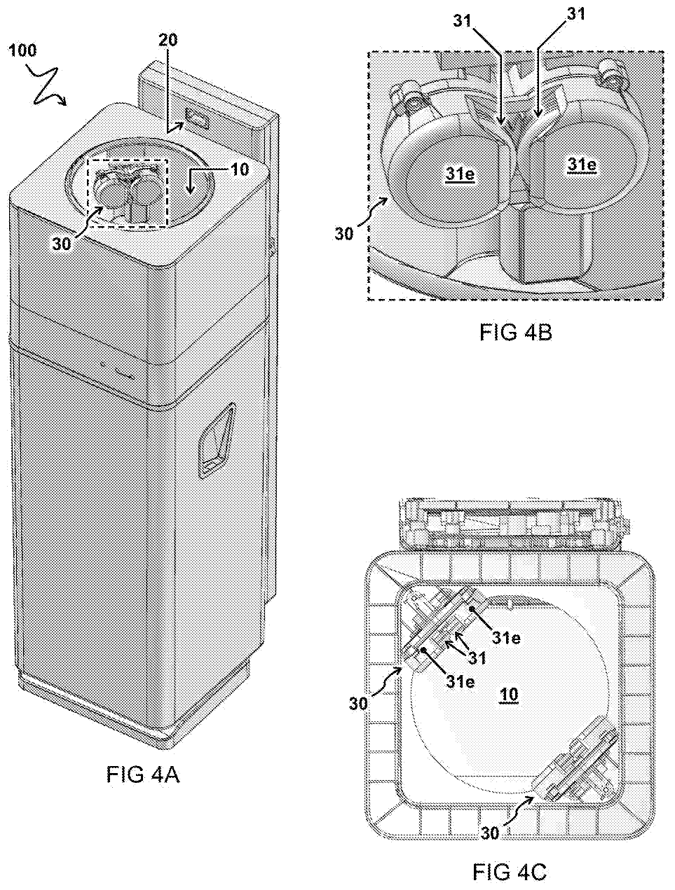

FIGS. 4A-4C illustrate further aspects of a pulling device 30 configured to pull a portion of flexible tubing (not shown here) from a surrounding supply compartment into the channel 10. FIG. 4B illustrates a close-up view of the system 100 illustrated in FIG. 4A; and FIG. 4C illustrates a cross-section top view of the same system 100. In some embodiments, as described before and illustrated in the present figures, the pulling device 30 comprises at least two counterrotating wheels 31 (or other rollers). For example, these may be used to grab an edge of the flexible tubing there between and pull the flexible tubing by the grabbed edge into the channel. In other or further embodiments, e.g. as illustrated in the close-up of FIG. 4B, the pulling device 30 comprises a partial enclosure 31e or casing, which partially encloses the wheels 31. In one embodiment, the partial enclosure 31e leaves a part of the wheels 31 exposed in a region where the wheels grab onto the flexible tubing, e.g. an inner region between the wheels. Preferably, the partial enclosure 31e at least partially covers other parts of the wheels, e.g. an outer region. Most preferably, the partial enclosure 31e completely encases the wheels except for the exposed inner region. Advantageously, the partial enclosure 31e may still allow the wheels to grab onto the flexible tubing while preventing or alleviating a problem where parts of the flexible tubing may get wrapped around the wheels, getting stuck.

While these and other figures illustrate preferred embodiments of the system having two pulling device 30, it will be understood that also more or fewer pulling devices can be used, e.g. one, three, or four. In one embodiment, e.g. as illustrated in FIG. 4A, the detection sensor 20 is integrated in a backplate. For example, the backplate can also be used to attach the system to a wall and/or house other electronic components including one or more of a controller, battery, et cetera. Integrating the sensor may provide a relatively robust construction and/or alleviate fouling of the sensor. Of course this feature could also be implemented in any of the other embodiments described herein, or the separate detection sensor 20 as shown in other embodiments could be used in the embodiment shown here. Also the backplate with or without electronic components can be provided in any of the other embodiment with or without an integrated detection sensor.

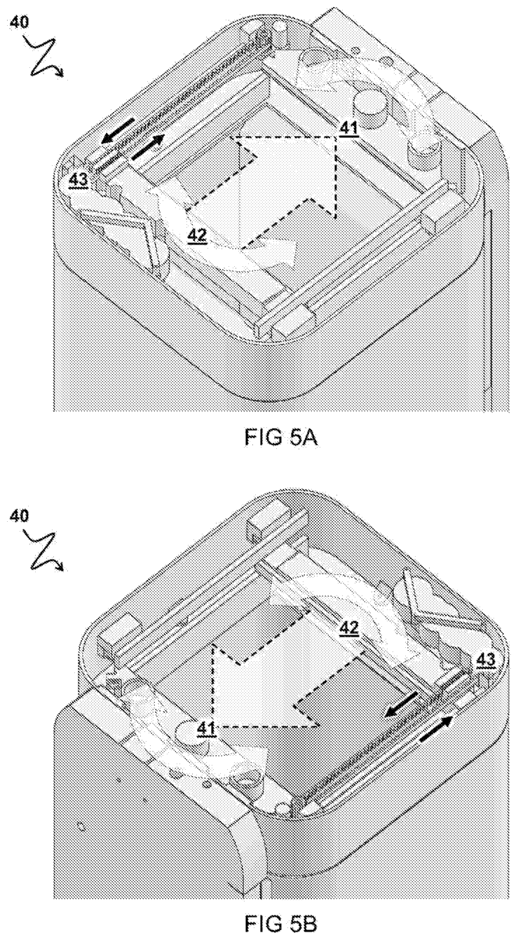

FIGS. 5A and 5B illustrate further aspects of a sealing device 40. In some embodiments, the sealing device 40 comprises at least one heating device 41. In one embodiment, the heating device 41 is configured to heat and/or fuse part of the flexible tubing (not shown here). For example, the heating device 41 comprises a heated wire that is pressed against a side of the flexible tubing. In another or further embodiment (not shown), two heating devices are configured to press the flexible tubing from opposite sides.

In other or further embodiments, the sealing device 40 comprises at least one pressing device 42. In one embodiment, the pressing device 42 is configured to press the flexible tubing together. For example, the pressing device 42 comprises at least one moving part, such as a pressing bar, that presses against a stationary part, e.g. sidewall or further pressing bar.

Having a stationary part, may simplify the design. Instead of an elongate bar, also other designs can be envisaged, e.g. a concave curved pressing bar which may reduce the contact area (not shown). It can also be envisaged to use two moving crossed bars (not shown) to push the flexible tubing in a corner. Preferably, at least the stationary part is provided with a heating device 41. Alternatively, or additionally, the one or more moving parts of the heating device 41 may be provided with a heating device.

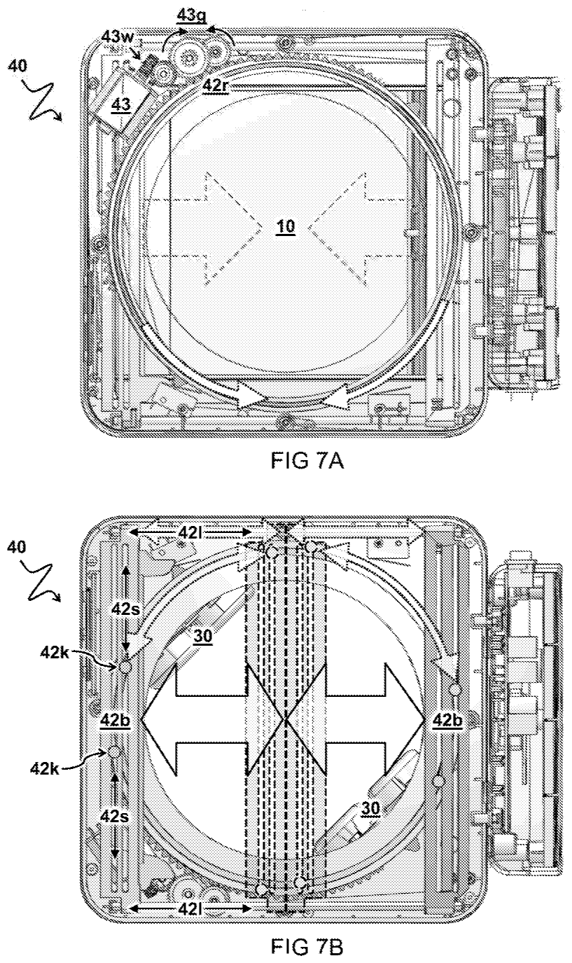

In other or further embodiments, e.g. as further discussed below with reference to FIGS. 7A and 7B, the sealing device 40 comprises two moving parts configured to press the flexible tubing together. This may allow the flexible tubing to be pressed more symmetrically. For example, one or both moving parts may be provided with one or more heating devices, or the flexible tubing may be sealed by pressure alone (e.g. comprising a pressure sealable material).

In some embodiments, the sealing device 40 comprises at least one actuator 43, e.g. motor, configured to actuate a moving part of the pressing device 42. For example, the actuator 43 may be connected to a pressing bar by one or more gears and/or a moving belt. Preferably, a toothed gear and/or belt is used to prevent slipping. In some embodiments, e.g. as shown the pressing device 42 comprises a pressing bar configured to be translated in a direction transverse, e.g. perpendicular, to a length of the bar. In one embodiment, the pressing bar is actuated by a motor and belt from one side. For example, the other side may be guided by an opposing mechanism. This may simplify the design. Alternatively both sides may be actuated, e.g. by a single actuator or two actuators. In one embodiment, at least one of the pressing bars is rotatable in addition to being translatable. This may improve contact there between also in case of irregularities in the pressed tubing.

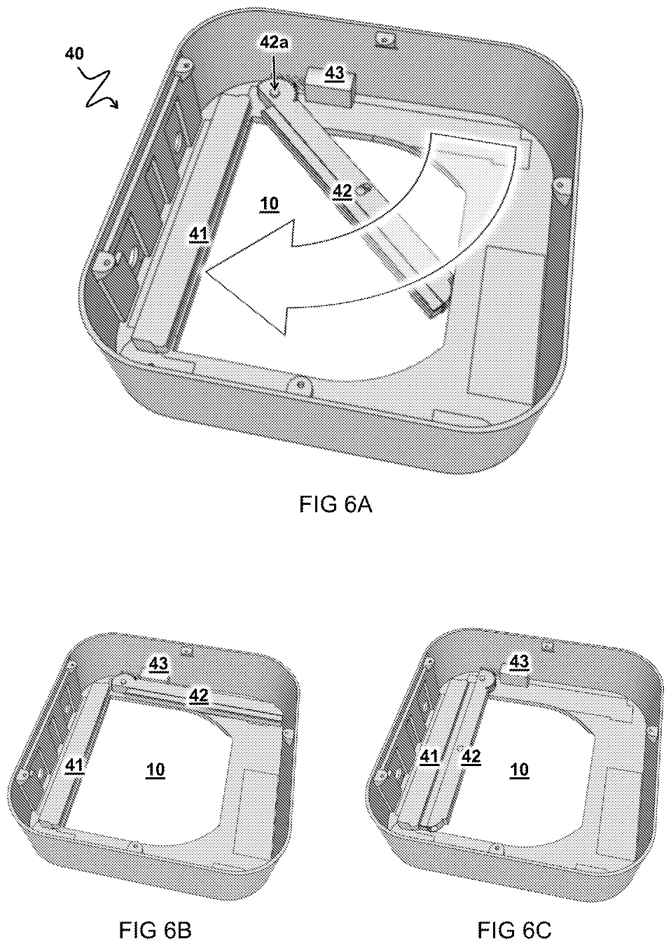

FIGS. 6A-6C illustrate aspects of another sealing device 40 in a midway, open, and closed position, respectively. In some embodiments, e.g. as shown, the sealing device 40 comprises at least one pressing device 42 with a pivoting arm configured to pivot around a rotational axis 42a at one side of the arm. In another or further embodiment, the pivoting arm is configured to sweep an area transverse to a length of the channel 10 for dragging part of the flexible tubing T, and press the flexible tubing T, to be sealed against an opposing part of the pressing device 42. Preferably, the opposing part is stationary and comprises the heating device 41. In one embodiment, e.g. as shown, the pivoting arm is (directly) connected to a motor via a worm gear. This may provide a particularly simple design capable of exerting sufficient pressure. Alternatively, a sufficiently strong motor could also be directly connected a gear on the axis 42a of the pivoting arm, or intermediary gears can be provided to increase torque.

FIGS. 7A and 7B respectively illustrate a top view and bottom view of a sealing device 40 comprising a set of movable parts configured to press the flexible tubing together, preferably in the middle of the channel 10. In some embodiments, the sealing device 40 comprises at least two parallel pressing bars 42b configured to controllably move towards and away from each other, e.g. in a symmetrical way. For example, the pressing bars 42b may respectively seal and release the flexible tubing there between. Advantageously, a pressing mechanism using parallel and/or symmetric sealing bars may ensure a relatively even distribution of forces and minimally displacement of the foil. This is found particularly beneficial in combination with the pulling devices as described herein. For example, the minimal displacement of the sealing mechanism may alleviate a potential issue that foil could be pulled away from the pulling mechanism 30, e.g. pulled away from the transport wheels.

In some embodiments, at least one, preferably both, of the pressing bars 42b are actuated by one or more actuators 43. In one embodiment, a drive mechanism including a set of gears 43g is arranged between a respective actuator 43 and one or more pressing bars 42b. In another or further embodiment, the set of gears 43 comprises at least two counter-rotating gears configured to drive respective pressing bars 42b in opposite directions. Preferably, the actuator 43 comprises an output shaft driving a worm gear 43w coupled to the set of gears 43g. This may improve torque. Of course the set of gears 43g may be coupled to the actuator in any other way; or separate actuators can be used, e.g. one for each pressing bar 42b.

In some embodiments, one or more actuators 43 are configured to directly or indirectly drive one or more rotating rings 42r configured to rotate around a circumference of the channel 10. Preferably, the set of rotating rings 42r comprises at least two counter-rotating rings, e.g. driven via a set of counter-rotating gears 43g as shown. Advantageously, the rotating rings 42r may use a single actuator. Alternatively, each ring may be driven by a respective actuator (not shown). In any case, the rotating rings may be used instead of a belt mechanisms that may be more prone to wear and/or failure. Furthermore, the mechanism is found to be relatively silent.

In some embodiments, the mechanical press 42 comprises a pair of pressing bars 42b configured to press the flexible tubing (T) together. In one embodiment, the pressing bars 42b are actuated via a pair of counter-rotating rings 42r configured to rotate around a circumference of the channel 10. In another or further embodiment, each pressing bar 42b comprises at least one, preferably two, elongate slots 42s along a length of each pressing bar 42b configured to couple with at least one, preferably two, knobs 42k attached to a respective rotating ring 42r. As illustrated in FIG. 7B, rotation of the respective ring may cause a respective knob 42k to rotate along a circumference of the channel 10, thereby causing the pressing bar 42b to move toward or away from a center of the channel 10. In another or further embodiment, the sealing device 40 comprises, for a respective pressing bar 42b, a pair of oppositely moving knobs 42k coupled to one or more slots 42s in the respective pressing bar 42b, wherein the oppositely moving knobs 42k are attached to a pair of counter-rotating rings 42r. As illustrated in FIG. 7B, rotation of the pair of counter-rotating rings 42r may cause the pair of oppositely moving knobs 42k to rotate in opposite directions along a circumference of the channel 10 thereby causing the respective pressing bar 42b to move in a direction transverse to a length of the elongate slots 42s. Alternative, or in addition, to the knobs 42k and slots 42s, also other or further types of coupling between the pressing bars (42b) and counter-rotating rings (42r) can be envisaged. In another or further embodiment, the sealing device 40 comprises a linear guidance 421 configured to guide the one or more pressing bars 42b, preferably in a direction perpendicular to a length of the respective pressing bar.

While the present embodiment shows a pair of oppositely moving pressing bars, it can also be envisaged to use a single pressing bar, e.g. moving towards a stationary bar across the channel (not shown). Also more than two pressing bars can be used, e.g. two pairs of bars in a crossed configuration (not shown). In some embodiments, the sealing device comprises a heating device, e.g. as described before. Preferably, the heating device is disposed in one or both of the pressing bars 42b, e.g. formed as a respective heated wire on a face of a respective pressing bar facing the opposite pressing bar comprising an opposing surface, e.g. silicone strip or other heat resistant and/or flexible material. Alternatively, or additionally, the flexible tubing may be sealed by pressure alone. As will be appreciated, the sealing device 40 comprising a pair of pressing bars 42b actuated via a pair of counter-rotating rings 42r, can be advantageously used in combination with the pulling device 30 comprising one or more pairs of counter-rotating wheels as described herein.

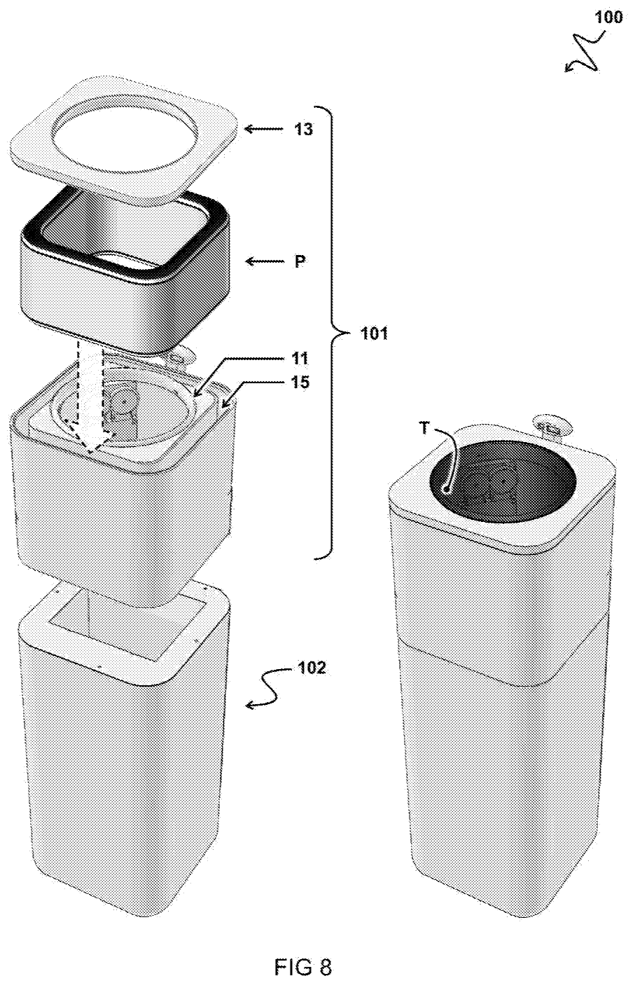

FIG. 8 illustrates modular parts of a waste disposal system 100, e.g. as described herein. In some embodiments, the system 100 comprises a top part 101 which can be mounted on a bottom part 102, and/or vice versa. For example, the bottom part 102 can be removed from the (fixed) top part 101. In one embodiment, a majority (preferably all) of the active parts of the system are arranged in the top part 101. For example, the top part 101 comprises one or more, preferably all, of the components described herein, such as the detection sensor 20, pulling device 30, and sealing device 40, controller, et cetera. The supply compartment 15 is preferably also arranged in the top part 101 of the system 100. In another or further embodiment, some active part may be provided in backplate, e.g. for mounting the system 100 on a wall. For example, the backplate can be integrally formed with the top part 101. The top part 101 may also be directly connectable to the wall, without a backplate. In another or further embodiment, the bottom part 102 comprises a waste container configured to hold a collection of sealed packages received from the top part 101. Preferably, the top part 101 is configured to function independent of the bottom part 102. Accordingly, the bottom part 102 can be easily exchanged and/or replaced. For example, the top part 101 is configured as a (separate) add-on which can be placed on a conventional waste container forming the bottom part 102. Alternatively, or in addition to an optional backplate, the system 100 may comprises a foot or other support structure for placement on the ground. For example, the top part 101 may be connected to the foot via a backplate or other connecting structure, and the bottom part 102 may be removable and/or exchangeable from between the top part 101 and foot; or the foot may be integrated in the bottom part 102; or the whole system of the top part 101, the bottom part 102, and optional foot may be integrated.

In some embodiments, the (modular or integrated) system 100 comprises an energy storage device such as a battery (not shown here) to power one or more, preferably all, of the components described herein, such as the detection sensor 20, pulling device 30, and sealing device 40 controller, et cetera. In one embodiment, the energy storage device is integrated as part of, or at least connected to, the top part 101, which may be modular. In another or further embodiment, the energy storage device is provided in a separate part, e.g. part for mounting the system on a wall, or anywhere else. In principle, the energy storage device could also be mounted in or on the bottom part 102. By not requiring an external power source, modularity of the system 100 may be further improved, especially if the energy storage device is mounted in the top part 101 and/or backplate. For example, the system 100 may be easily installed in a (public) bathroom, or elsewhere, without requiring an electrical connection, and can even be installed on top of an existing waste container. Alternatively, or additionally, the system may include at least an option for being powered by an external power supply. Accordingly, the system may use external power where this is readily available.

In some embodiments, the supply compartment 15 is configured to house a package or supply package “P” containing the flexible tubing T for supply to the system. Typically, the supply package “P” comprises a preformed (folded) tube with a length (when it is unfolded) of at least ten meter, preferably at least twenty meter, more preferably at least thirty meter, most preferably at least forty meter, e.g. up to fifty meter, or more. To provide sufficient length of folded tubing in a limited volume of the supply compartment 15, preferably the flexible tubing T is relatively thin. For example, the flexible tubing T has a thickness less than twenty-five micrometer, preferably less than ten micrometer, e.g. down to six micrometer, or less. Typically, the flexible tubing T comprises or is essentially formed of plastic, preferably polyethylene (PE), such as low density poly ethylene (LDPE), more preferably linear low density poly ethylene (LLDPE), or high density polyethylene (HDPE).

In some embodiments, the system 100 comprises a controller configured to determine an indication the flexible tubing T used, e.g. since a last refill and/or reset. For example, the controller is configured to count a number of sealed packages created and/or measure a length of the tubing used in creating sealed packages. In other or further embodiments, the controller is configured to keep track of a remaining length of the flexible tubing T which can be used to created sealed packages. For example, the system 100 subtracts the used length of tubing from a length of tubing initially available in the supply package “P”. In one embodiment, the controller is configured to provide a signal when the used amount of tubing passes a threshold and/or the remaining amount of tubing drops below a threshold. For example, the signal can be a digital signal, e.g. provided to another component or system and/or an audio and/or visible signal provided to a user to signal either that the supply of tubing has run out, or will soon run out; or that the container is full or nearly full. Alternatively, or in addition, the system may halt operation, e.g. when the container is too full or there is no remaining tubing. The system may also comprise a sensor to detect the remaining tubing or when the tubing has run out (e.g. when the tubing is no longer detected).

In some embodiments, the system is configured to detect when a supply package “P” is exchanged. In one embodiment, the system is provided with a sensor to detect removal/replacement of the cover 13 and/or supply package “P”. In another or further embodiment, the count of remaining flexible tubing is reset based on the detected exchange. In other or further embodiments, the system is configured to detect when the waste container has been emptied. In one embodiment, the system is provided with a sensor to detect removal/replacement of the waste container 102. In another or further embodiment, the system is provided with a sensor configured to measure a weight of the waste container, e.g. bottom part 102. For example, the bottom part 102 hangs from a weight sensor on the top part 101. When the weight of the waste container exceeds a threshold it may be determined that the waste container is full. Alternatively, or in addition to a weight sensor, the system may also comprise a sensor to directly detect waste packages in the waste container. For example, an optical sensor is arranged at the bottom of the top part 101 to measure a level of waste in the container 102 below.

In some embodiments, the supply compartment 15 is provided with a sensor configured to detect the supply package “P”. In other or further embodiments, the system is configured to determine a length of the flexible tubing T provided in the supply package “P” based on a sensor measurement. In one embodiment, the supply compartment 15 comprises a sensor to measure the remaining supply of flexible tubing T, e.g. by measuring a weight of the supply package “P”. In another or further embodiment, the supply compartment 15 comprises a sensor to read out a type of the supply package “P”. For example, the supply compartment 15 comprises a scanner, e.g. to read a logo, bar code, QR code, and/or RFID chip disposed on or in the supply package “P”. Accordingly, a predetermined length of the flexible tubing T may be determined based on the detected supply package “P”.

In some embodiments (not shown), the system 100 comprises a communication device. In one embodiment, the communication device is configured to communicate a status of the system or other signal, e.g. to a remote location. Preferably, the communication device is configured to use a short-range and/or long-range wireless communication signal, e.g. Bluetooth, ZigBee, Wi-Fi, LPWAN (such as LoRa/LoRaWAN), Cellular signal, et cetera. In one embodiment, the communication device is configured to use a short-range signal (such as Bluetooth, ZigBee) to alert a nearby service crew or signal relay point. In another or further embodiment, the communication device is configured to use a long-range signal (Wi-Fi, LPWAN, Cellular signal) to alert a central control and/or monitoring system. For example, the system may communicate a status including at least one of an indication that the remaining supply of tubing has fallen below a threshold value, an indication the container 102 is (nearly) full, an indication that the container 102 has not been emptied for a threshold period of time, an indication that the system is malfunctioning (e.g. stuck waste product, no tubing in the pulling device, et cetera). The system may also communicate current and/or past sensor measurements, e.g. a log of sensor measurements.

In interpreting the appended claims, it should be understood that the word “comprising” does not exclude the presence of other elements or acts than those listed in a given claim; the word “a” or “an” preceding an element does not exclude the presence of a plurality of such elements; any reference signs in the claims do not limit their scope; several “means” may be represented by the same or different item(s) or implemented structure or function; any of the disclosed devices or portions thereof may be combined together or separated into further portions unless specifically stated otherwise. Where one claim refers to another claim, this may indicate synergetic advantage achieved by the combination of their respective features. But the mere fact that certain measures are recited in mutually different claims does not indicate that a combination of these measures cannot also be used to advantage.

1. A system for disposing waste products in sealed packages made from a flexible tubing, the system comprising:
a channel for passing a waste product inside a flexible tubing being drawn from a supply compartment over a circumferential edge formed around an entrance to the channel;
a detection sensor configured to detect the waste product being passed into the channel;
a pulling device configured to pull a portion of the flexible tubing into the channel from the surrounding supply compartment based on the detecting; and
a sealing device configured to seal a portion of the flexible tubing that has been pulled into the channel to form a sealed package with the waste product inside.

2. The system according to claim 1, wherein the pulling device comprises at least one pair of counterrotating wheels configured to grab at least one folded edge of the flexible tubing, and pull the flexible tubing, by the at least one folded edge, into the channel.

3. (canceled)

4. The system according to claim 2, wherein each of the wheels have a toroidal outer edge formed of a resilient material configured to grab and hold the flexible tubing there between.

5. The system according to claim 1, wherein the pulling device is arranged inside the channel between the channel entrance and the sealing device.

6. The system according to claim 1, comprising at least two pulling devices arranged on opposite walls inside the channel and configured to grab onto opposing folded edges of the flexible tubing for pulling the flexible tubing into the channel.

7. The system according to claim 1, wherein the detection sensor is configured to generate a detection signal upon detecting a presence of the waste product above the entrance to the channel, before entering the channel, the system comprising a controller configured to automatically initiate disposal of the waste product upon receiving the detection signal from the detection sensor by first activating the pulling device to pull a portion of the flexible tubing into the channel and then activating the sealing device to seal the flexible tubing to form the sealed package with the waste product inside.

8. The system according to claim 7, wherein the controller is configured to determine an indication an amount of the flexible tubing used and/or remaining in a supply package provided in the supply compartment, and to provide a signal when the used amount of the flexible tubing passes a threshold amount and/or the remaining amount of the flexible tubing drops below a threshold amount.

9. The system according to claim 8, comprising a sensor configured to detect exchange of a supply package in the supply compartment and/or removal of waste products from a bottom part containing the scaled packages, wherein the controller is configured to reset an amount of the flexible tubing remaining in the supply package upon detecting the exchange and/or reset an amount of the flexible tubing counted towards reaching a threshold capacity of the supply compartment.

10. The system according to claim 9, wherein the controller is configured to disable the pulling device based on detecting that the supply compartment and/or waste container is open or removed during exchange of a supply package and/or emptying of the waste container.

11. The system according to claim 1, wherein the circumferential edge is formed by a circumferential rim surrounding the entrance to the channel, wherein the supply compartment is arranged circumferentially around and adjacent the channel, wherein the supply compartment comprises a circumferential slot around the circumferential rim for feeding the flexible tubing from the surrounding supply compartment up through the circumferential slot and down over the circumferential rim into the channel, wherein the supply compartment comprises a removable cover for exchanging and/or refilling the supply of flexible tubing, wherein the circumferential slot is formed between the removable cover and the circumferential rim.

12. The system according to claim 11, wherein the circumferential rim has a rounded and smooth top profile that extends a distance above the surrounding removable cover, wherein the circumferential rim is arranged in a path of the flexible tubing between the supply compartment and the pulling device.

13. The system according to claim 1, comprising a top part configured to be mounted on a bottom part forming a waste container configured to receive sealed packages from the top part, wherein the top part comprises at least the supply compartment, the detection sensor, the pulling device, and the sealing device, the system further comprising an energy storage device mounted in the top part, or in a backplate, separate from the bottom part.

14. The system according to claim 1, wherein the sealing device comprises a mechanical press with a pair of pressing bars configured to press a part of the flexible tubing together, pressing the part of the flexible tubing against a heating device disposed in one or both of the pressing bars, wherein the pressing bars are actuated via a pair of counter-rotating rings configured to rotate around a circumference of the channel.

15. A method for disposing waste products in scaled packages made from a flexible tubing, the method comprising:
passing a waste product inside the flexible tubing drawn from a supply compartment over a circumferential edge formed around an entrance to a channel;
detecting the waste product being passed into the channel;
pulling, based on the detecting, a portion of the flexible tubing into the channel from the surrounding supply compartment; and
sealing a portion of the flexible tubing that has been pulled into the channel to form a sealed package with the waste product inside.

16. The method according to claim 15, wherein said pulling comprises two pairs of counter-rotating wheels grabbing onto opposing folded edges of the flexible tubing and pulling the flexible tubing, by the opposing folded edges, into the channel.

17. The method according to claim 16, wherein each of the wheels have a toroidal outer edge formed of a resilient material configured to grab and hold the flexible tubing therebetween.

18. The method according to claim 15, further comprising automatically initiating disposal of the waste product upon detecting the waste product by first pulling a portion of the flexible tubing into the channel and then sealing the flexible tubing to form the sealed package with the waste product inside.

19. The method according to claim 15, wherein passing the waste product comprises passing the flexible tubing over a circumferential rim surrounding the entrance to the channel, the flexible tubing being fed from a supply compartment arranged circumferentially around and adjacent to the channel through a circumferential slot formed between a removable cover and the circumferential rim, wherein the circumferential rim has a rounded and smooth top profile that extends a distance above the surrounding removable cover and is arranged in a path of the flexible tubing between the supply compartment and the pulling step.

20. The method according to claim 15, wherein sealing comprises pressing a part of the flexible tubing together using a mechanical press with a pair of pressing bars, pressing the part of the flexible tubing against a heating device disposed in one or both of the pressing bars, wherein the pressing bars are actuated via a pair of counter-rotating rings configured to rotate around a circumference of the channel.

21. The method according to claim 15, wherein the waste product being passed into the channel is detected using a detection sensor configured to detect a presence of the waste product above the entrance to the channel, before entering the channel.
